(19) United States
(12) Patent Application Publication
(10) Pub. No.: US 2009/0189578 A1
(43) Pub. Date: Jul. 30, 2009

(54) LOW RIPPLE DC TO DC POWER CONVERTER

(76) Inventors: Tien-Tzu Chen, Hsinchu City (TW); Li-Cheng Chen, Kaohsiung City (TW)

Correspondence Address: NORTH AMERICA INTELLECTUAL PROPERTY CORPORATION, P.O. BOX 506, MERRIFIELD, VA, 22116, US

(21) Appl. No.: 12/020,584

(22) Filed: Jan. 28, 2008

(51) Int. Cl. G05F 1/00

(52) U.S. Cl. 323/282

(57) ABSTRACT

A low ripple DC to DC power converter comprises a first switch, a second switch, an inductor, a driving circuit, and an oscillating circuit. The driving circuit is used to control the first switch and the second switch based on a driving signal. The driving signal has a duty cycle. The oscillating circuit comprises a first oscillating signal and a second oscillating signal. The first oscillating signal has a first pulse width and the second oscillating signal has a second pulse width. The oscillating circuit is used to generate a pulse oscillating signal, where the frequency of the pulse oscillating signal is modulated based on the duty cycle, the first pulse width, and the second pulse width so as to reduce the ripple of the output voltage.

### BACKGROUND OF THE INVENTION

1. Field of the Invention

The present invention relates to a DC to DC power converter and, more particularly, to a low ripple DC to DC power converter.

2. Description of the Related Art

FIG. 1 is a circuit diagram showing a conventional DC to DC power converter 10. The DC to DC power converter 10 converts an input voltage Vᵢₙ₁ into an output voltage Vₒ₁ for being supplied to a load Ld1. A switch SH1 is coupled between the input voltage Vᵢₙ₁ and a switch node N1 while a switch SL1 is coupled between the switch node N1 and a ground potential. As to the example of FIG. 1, the switch SH1 is implemented by a PMOS transistor while the switch SL1 is implemented by a NMOS transistor. An inductor L1 is coupled between the switch node N1 and an output terminal O1. An output capacitor Cₒ₁ is coupled to the output terminal O1 for filtering the output voltage Vₒ₁.

The DC to DC power converter 10 comprises an oscillating circuit 11, a latch 12, a PWM control circuit 13, and a driving circuit 14. The oscillating circuit 11 generates a pulse oscillating signal PL1 and a ramp oscillating signal RM1, both of which are in synchronization with respect to each other. The rising edge of the pulse oscillating signal PL1 is corresponding to the peak of the ramp oscillating signal RM1 while the falling edge of the pulse oscillating signal PL1 is corresponding to the valley of the ramp oscillating signal RM1. The pulse oscillating signal PL1 is applied to a set terminal S of the latch 12 while the ramp oscillating signal RM1 is applied to the PWM control circuit 13. When the rising edge of the pulse oscillating signal PL1 triggers the latch 12 through the set terminal S, the driving signal DR1 from the output terminal Q of the latch 12 changes into a high level. Through the driving circuit 14, the high level of the driving signal DR1 turns on the switch SH1 and turns off the switch SL1, such that the DC to DC power converter 10 enters the so-called ON operating phase. During the ON operating phase, the current of the inductor L1 gradually increases.

A voltage feedback signal FV1 is representative of the output voltage Vₒ₁ while a current feedback signal FI1 is representative of the current of the inductor L1. In response to the voltage feedback signal FV1, the current feedback signal FI1, and the ramp oscillating signal RM1, the PWM control circuit 13 applies a control signal CS1 to a reset terminal R of the latch 12. Regardless of the current mode or the voltage mode adopted in the PWM control method, the driving signal DR1 from the output terminal Q of the latch 12 changes into a low level when the control signal CS1 triggers the latch 12 through the reset terminal R. Through the driving circuit 14, the low level of the driving signal DR1 turns off the switch SH1 and turns on the switch SL1, such that the DC to DC power converter 10 enters the so-called OFF operating phase. During the OFF operating phase, the current of the inductor L1 gradually decreases.

More specifically, the DC to DC power converter 10 shown in FIG. 1 belongs to the step-down type, i.e., converting a higher input voltage Vᵢₙ₁ into a lower output voltage Vₒ₁. The step-down DC to DC power converter 10 has a duty cycle Du as expressed in the following equation (1):

$$Du ≡ \frac{{T}_{ON}}{( {T}_{ON} + {T}_{OFF} )} = \frac{{V}_{o 1}}{{V}_{in 1}} \qquad ( 1 )$$

where T_{ON} is representative of the time of the ON operating phase each period while T_{OFF} is representative of the time of the OFF operating phase each period. The sum of T_{ON} and T_{OFF} equals to the period T_{TOL} of the pulse oscillating signal PL1 (or the ramp oscillating signal RM1).

As appreciated from equation (1), T_{ON} becomes longer when the input voltage Vᵢₙ₁ becomes closer to the output voltage Vₒ₁. The increase of T_{ON} causes T_{OFF} to decrease since the period T_{TOL} of the pulse oscillating signal PL1 is a constant. However, when the switch SH1 is turned off from on and the switch SL1 is turned on from off, a finite physical time is necessary for the accumulation and depletion of the charges. Therefore, T_{OFF} must be limited to being larger than a predetermined minimum T_{OFF, min} for allowing an appropriate switching operation to be possible. Therefore, the maximum Du is 1−T_{OFF, min}/T_{TOL} for normal operation. When the input voltage Vᵢₙ₁ is lower than [T_{TOL}/(T_{TOL}−T_{OFF, min})]*Vₒ₁, the DC to DC power converter 10 operates in an abnormal mode, resulting that the ripple of the output voltage Vₒ₁ becomes large.

### SUMMARY OF THE INVENTION

In view of the above-mentioned problem, an object of the present invention is to provide a DC to DC power converter which reduces the ripple of the output voltage.

According to the present invention, a DC to DC power converter is provided for converting an input voltage into an output voltage. The DC to DC power converter comprises a first switch, a second switch, an inductor, a driving circuit, and an oscillating circuit. The driving circuit is used to control the first switch and the second switch based on a driving signal, where the driving signal has a duty cycle. The oscillating circuit comprises a first oscillating signal and a second oscillating signal. The first oscillating signal has a first pulse width w1 and the second oscillating signal has a second pulse width w2. The oscillating circuit is used to generate a pulse oscillating signal. The pulse oscillating signal has a frequency and the initial value of the frequency is F. The frequency is modulated based on the duty cycle, the first pulse width w1, and the second pulse width w2. When the frequency is F and the duty cycle is greater than 1−F*w1, the frequency will be modulated to be 0.5° F. When the frequency is 0.5° F. and the duty cycle is greater than 1−F*w1/2, the frequency will be modulated to be 0.25° F. When the frequency is 0.5° F. and the duty cycle is less than 1−F*w2/2, the frequency will be modulated to be F. When the frequency is 0.25° F. and the duty cycle is greater than 1−F*w1/4, the frequency will be modulated to 0.125° F. When the frequency is 0.25° F. and the duty cycle is less than 1−F*w2/4, the frequency will be modulated to 0.5° F. When the frequency is 0.125° F. and the duty cycle is less than 1−F*w2/8, the frequency will be modulated to 0.25° F. When the frequency is 0.5° F. and the duty cycle is between 1−F*w2/2 and 1−F*w1/2, the frequency will be kept to be 0.5° F. When the frequency is 0.25° F. and the duty cycle is between 1−F*w2/4 and 1−F*w1/4, the frequency will be kept to be 0.25° F. Therefore, the frequency of the pulse oscillating signal is adaptively modulated so as to reduce the ripple of the output voltage.

### BRIEF DESCRIPTION OF THE DRAWINGS

The above-mentioned and other objects, features, and advantages of the present invention will become apparent with reference to the following descriptions and accompanying drawings, wherein:

FIG. 1 is a circuit diagram showing a conventional DC to DC power converter;

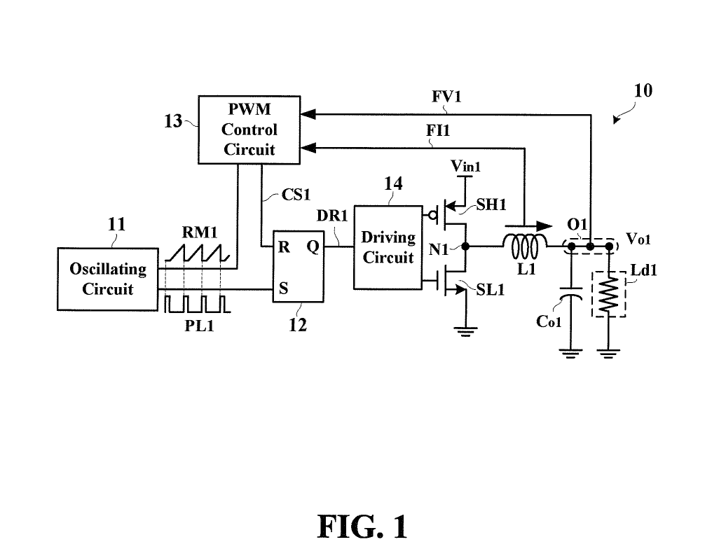

FIG. 2 is a circuit diagram showing a DC to DC power converter according to the present invention;

FIG. 3 is a detailed circuit diagram showing an oscillating circuit according to the present invention;

FIG. 4 is a detailed circuit diagram showing a control circuit according to the present invention;

FIGS. 5(a)-5(c) illustrate some timing charts according to the present invention;

FIG. 6 shows the variation of the frequency of the pulse oscillating signal based on a duty cycle according to the present invention;

### DETAILED DESCRIPTION OF THE PREFERRED EMBODIMENTS

The preferred embodiment according to the present invention will be described in detail with reference to the drawings.

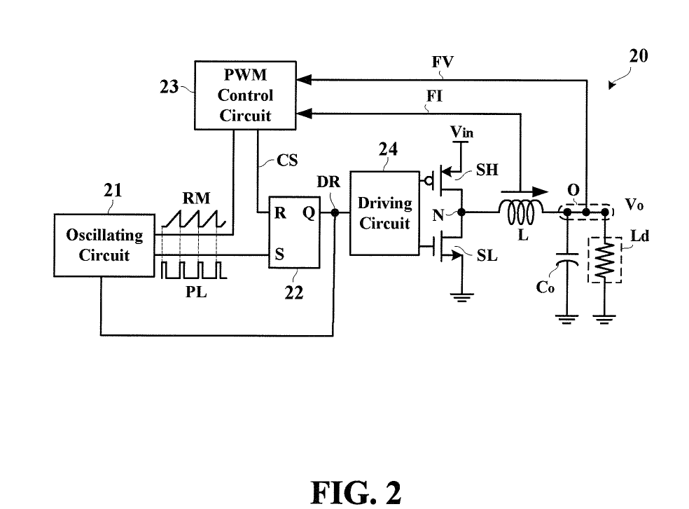

FIG. 2 is a circuit diagram showing a DC to DC power converter 20 according to the present invention. The DC to DC power converter 20 converts an input voltage Vᵢₙ into an output voltage Vₒ for being supplied to a load Ld. A switch SH is coupled between the input voltage Vᵢₙ and a switch node N while a switch SL is coupled between the switch node N and a ground potential. As to the example of FIG. 2, the switch SH is implemented by a PMOS transistor while the switch SL is implemented by a NMOS transistor. An inductor L is coupled between the switch node N and an output terminal O. An output capacitor Cₒ is coupled to the output terminal O for filtering the output voltage Vₒ.

The DC to DC power converter 20 comprises an oscillating circuit 21, a latch 22, a PWM control circuit 23, and a driving circuit 24. The oscillating circuit 21 generates a pulse oscillating signal PL and a ramp oscillating signal RM, both of which are in synchronization with respect to each other. The rising edge of the pulse oscillating signal PL is corresponding to the peak of the ramp oscillating signal RM while the falling edge of the pulse oscillating signal PL is corresponding to the valley of the ramp oscillating signal RM. The pulse oscillating signal PL is applied to a set terminal S of the latch 22 while the ramp oscillating signal RM is applied to the PWM control circuit 23. When the rising edge of the pulse oscillating signal PL triggers the latch 22 through the set terminal S, the driving signal DR from the output terminal Q of the latch 22 changes into a high level. Through the driving circuit 24, the high level of the driving signal DR turns on the switch SH and turns off the switch SL, such that the DC to DC power converter 20 enters the so-called ON operating phase. During the ON operating phase, the current of the inductor L gradually increases.

A voltage feedback signal FV is representative of the output voltage Vₒ while a current feedback signal FI is representative of the current of the inductor L. In response to the voltage feedback signal FV, the current feedback signal FI, and the ramp oscillating signal RM, the PWM control circuit 23 applies a control signal CS to a reset terminal R of the latch 22. Regardless of the current mode or the voltage mode adopted in the PWM control method, the driving signal DR from the output terminal Q of the latch 22 changes into a low level when the control signal CS triggers the latch 22 through the reset terminal R. Through the driving circuit 24, the low level of the driving signal DR turns off the switch SH and turns on the switch SL, such that the DC to DC power converter 20 enters the so-called OFF operating phase. During the OFF operating phase, the current of the inductor L gradually decreases.

The driving signal DR is also used to adaptively modulate the frequency of the pulse oscillating signal PL and the ramp oscillating signal RM via the oscillating circuit 21. When the voltage difference between the input voltage Vᵢₙ and the output voltage Vₒ decreases, the duty cycle D of the driving signal DR increases. At this moment the oscillating circuit 21 decreases the frequency of the pulse oscillating signal PL and the ramp oscillating signal RM based on the duty cycle D, so as to reduce the ripple of the output voltage Vₒ. When the voltage difference between the input voltage Vᵢₙ and the output voltage Vₒ increases, the duty cycle D decreases. At this moment the oscillating circuit 21 increases the frequency of the pulse oscillating signal PL and the ramp oscillating signal RM based on the duty cycle D.

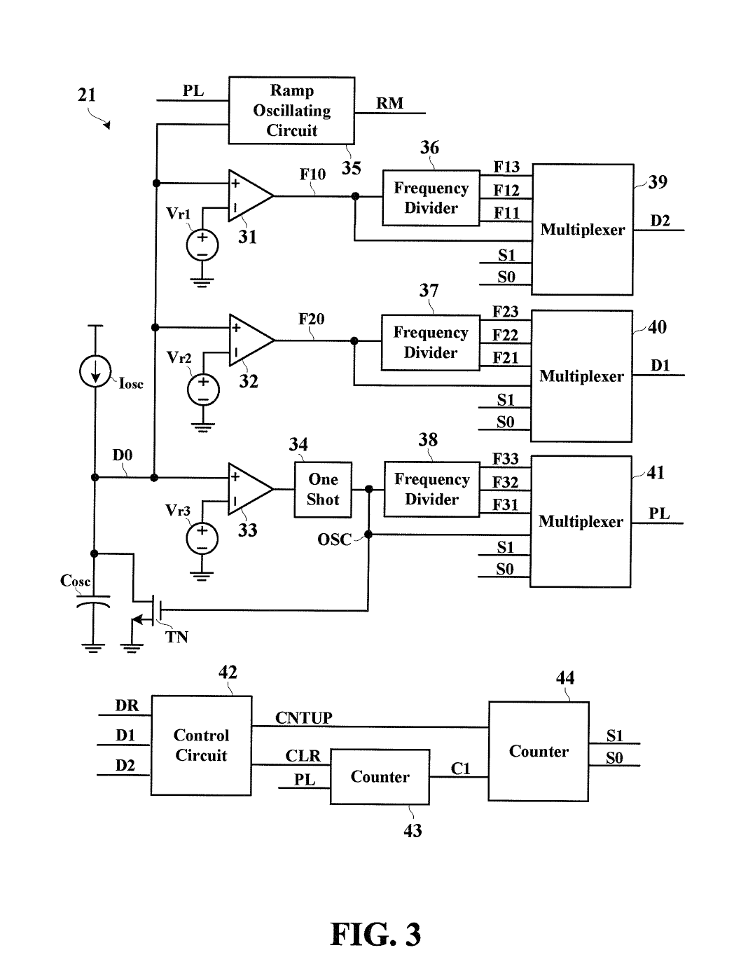

FIG. 3 is a detailed circuit diagram showing the oscillating circuit 21 according to the present invention. The oscillating circuit 21 comprises comparators 31-33, a one shot 34, a ramp oscillating circuit 35, frequency dividers 36-38, multiplexers 39-41, a control circuit 42, counters 43-44, reference voltage sources Vᵣ₁-Vᵣ₃, a current source I_{OSC}, a capacitor C_{OSC}, and a transistor TN. The non-inverted input terminal of the comparator 33 receives the voltage of the oscillating signal D0, and the inverted input terminal of the comparator 33 receives the voltage of the reference voltage source Vᵣ₃. When the voltage of the oscillating signal D0 exceeds the voltage of the reference voltage source Vᵣ₃, the comparator 33 outputs a rising-edge output signal so as to trigger the one shot 34 to generate an oscillating signal OSC. When the oscillating signal OSC is at the high level, the transistor TN is turned on and the voltage of the oscillating signal D0 decreases to the ground potential. When the oscillating signal OSC is at the low level, the transistor TN is turned off. The current source I_{OSC} immediately charges the capacitor C_{OSC}, thereby gradually increasing the voltage of the oscillating signal D0. The non-inverted input terminal of the comparator 31 receives the voltage of the oscillating signal D0 and the inverted input terminal of the comparator 31 receives the voltage of the reference voltage source Vᵣ₁, so as to generate an oscillating signal F10. The pulse width of the oscillating signal F10 can be changed by adjusting the voltage of the reference voltage source Vᵣ₁. The non-inverted input terminal of the comparator 32 receives the voltage of the oscillating signal D0 and the inverted input terminal of the comparator 32 receives the voltage of the reference voltage source Vᵣ₂, so as to generate an oscillating signal F20. The pulse width of the oscillating signal F20 can be changed by adjusting the voltage of the reference voltage source Vᵣ₂. The oscillating signal OSC, the oscillating signal F10, and the oscillating signal F20 have the same period T and the same frequency F, where F=1/T. Furthermore, the ramp oscillating circuit is used to generate the ramp oscillating signal RM based on the oscillating signal D0 and the pulse oscillating signal PL.

The frequency divider 36 is used to generate oscillating signals F11-F13 based on the oscillating signal F10, where the frequency of the oscillating signal F11 is 0.5° F., the frequency of the oscillating signal F12 is 0.25° F., and the frequency of the oscillating signal F13 is 0.125° F. The multiplexer 39 is used to choose one of oscillating signals F10-F13 to generate the oscillating signal D2, based on the counting signals S0 and S1. When the counting signals S0 and S1 are at the low level, the oscillating signal D2 is equal to the oscillating signal F10. When the counting signal S0 is at the high level and the counting signal S1 is at the low level, the oscillating signal D2 is equal to the oscillating signal F11. When the counting signal S0 is at the low level and the counting signal S1 is at the high level, the oscillating signal D2 is equal to the oscillating signal F12. When the counting signals S0 and S1 are at the high level, the oscillating signal D2 is equal to the oscillating signal F13. Similarly, the frequency divider 37 is used to generate oscillating signals F21-F23 based on the oscillating signal F20, where the frequency of the oscillating signal F21 is 0.5° F., the frequency of the oscillating signal F22 is 0.25° F., and the frequency of the oscillating signal F23 is 0.125° F. The multiplexer 40 is used to choose one of oscillating signals F20-F23 to generate the oscillating signal D1, based on the counting signals S0 and S1. When the counting signals S0 and S1 are at the low level, the oscillating signal D1 is equal to the oscillating signal F20. When the counting signal S0 is at the high level and the counting signal S1 is at the low level, the oscillating signal D1 is equal to the oscillating signal F21. When the counting signal S0 is at the low level and the counting signal S1 is at the high level, the oscillating signal D1 is equal to the oscillating signal F22. When the counting signals S0 and S1 are at the high level, the oscillating signal D1 is equal to the oscillating signal F23. In addition, the frequency divider 38 is used to generate oscillating signals F31-F33 based on the oscillating signal OSC, where the frequency of the oscillating signal F31 is 0.5° F., the frequency of the oscillating signal F32 is 0.25° F., and the frequency of the oscillating signal F33 is 0.125° F. The multiplexer 41 is used to choose one of oscillating signals OSC and F31-F33 to generate the pulse oscillating signal PL, based on the counting signals S0 and S1. When the counting signals S0 and S1 are at the low level, the pulse oscillating signal PL is equal to the oscillating signal OSC. When the counting signal S0 is at the high level and the counting signal S1 is at the low level, the pulse oscillating signal PL is equal to the oscillating signal F31. When the counting signal S0 is at the low level and the counting signal S1 is at the high level, the pulse oscillating signal PL is equal to the oscillating signal F32. When the counting signals S0 and S1 are at the high level, the pulse oscillating signal PL is equal to the oscillating signal F33. Therefore, the pulse oscillating signal PL and oscillating signals D1-D2 have the same frequency any time.

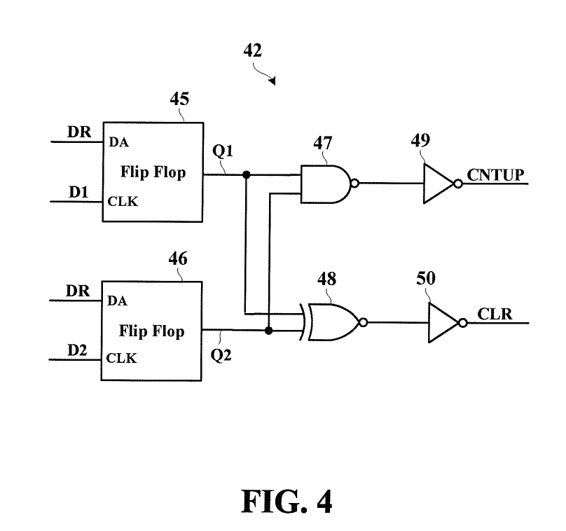

The control circuit 42 receives the driving signal DR and oscillating signals D1-D2 to output control signals CNTUP and CLR. The counter 43 receives the control signal CLR and the pulse oscillating signal PL to output the control signal C1. The counter 44 receives control signals CNTUP and C1 so as to output counting signals S0 and S1, where the initial values of counting signals S0 and S1 are at a low level. Thus, the value of the counter 44 is zero in the beginning. The control signal CNTUP is used to specify the upcount/downcount of the counter 44. The bit count of the counter 44 is two, where the counting signal S0 is a low-bit signal while the counting signal S1 is a high-bit signal. FIG. 4 is a detailed circuit diagram showing the control circuit 42 according to the present invention. The control circuit 42 comprises flip flops 45-46, a NAND gate 47, an exclusive NOR gate 48, and NOT gates 49-50. The data terminal DA of the flip flop 45 is coupled to the driving signal DR and the clock terminal CLK of the flip flop 45 is coupled to the oscillating signal D1, so as to generate an output signal Q1 to the NAND gate 47 and the exclusive NOR gate 48. The data terminal DA of the flip flop 46 is coupled to the driving signal DR and the clock terminal CLK of the flip flop 46 is coupled to the oscillating signal D2, so as to generate an output signal Q2 to the NAND gate 47 and the exclusive NOR gate 48. The input terminal of the NOT gate 49 is coupled to the output terminal of the NAND gate 47 in order to generate the control signal CNTUP, while the input terminal of the NOT gate 50 is coupled to the output terminal of the exclusive NOR gate 48 in order to generate a control signal CLR.

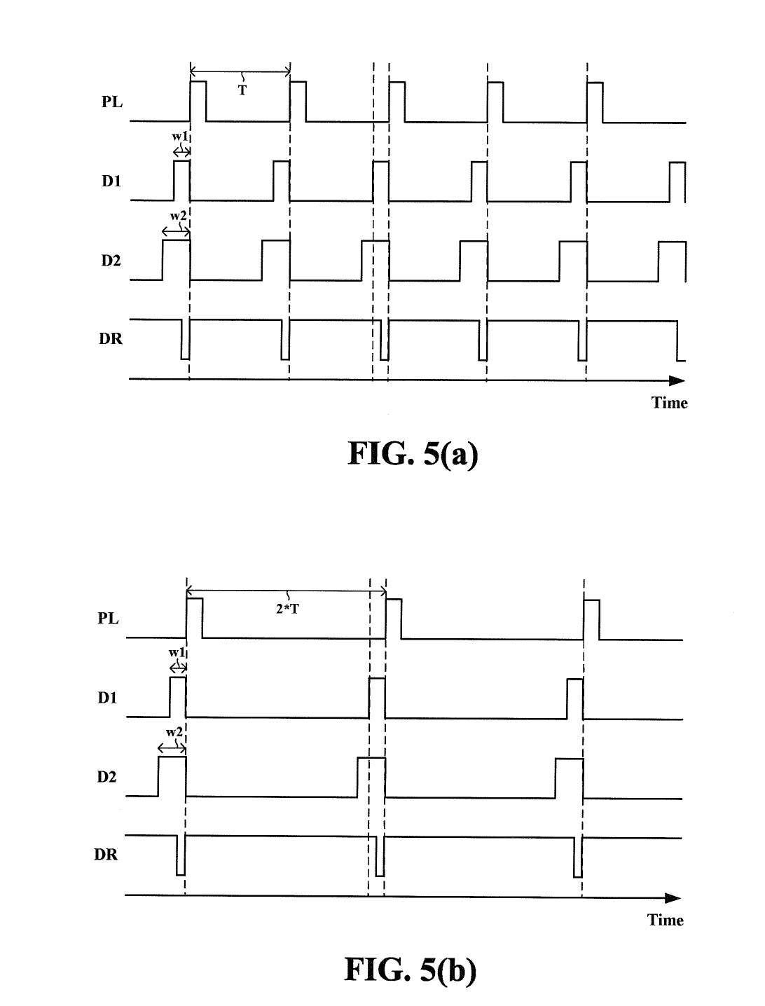

FIGS. 5(a)-5(c) illustrate timing charts of the pulse oscillating signal PL, oscillating signals D1-D2, and the driving signal DR. As shown in FIG. 5(a), since the initial values of counting signals S0 and S1 are at the low level, the pulse oscillating signal PL is equal to the oscillating signal OSC. In addition, the oscillating signal D1 is equal to the oscillating signal F20 and the oscillating signal D2 is equal to the oscillating signal F10. The oscillating signal D1 has a pulse width w1 while the oscillating signal D2 has a pulse width w2, where w2>2*w1. Such requirement should be met to avoid the frequency of the pulse oscillating signal PL being unstable. In this embodiment the pulse width w1 is chosen to be equal to 100 ns and the pulse width w2 is chosen to be equal to 250 ns. The frequency F is chosen to be equal to 1 MHz and thus the period T is equal to 1 μs.

Refer to FIG. 3, FIG. 4, and FIG. 5(a) at the same time for the detailed operation of the oscillating circuit 21. When the duty cycle D of the driving signal DR is greater than 1−F*w1, both the flip flops 45 and 46 sample to the high-level driving signal DR, thereby enabling the control signal CNTUP to be at the high level and the control signal CLR to be at the low level. Then if the duty cycle D is greater than 1−F*w1 for N consecutive periods of the pulse oscillating signal PL, the counter 43 will generate the rising-edge control signal C1 so as to specify an upcount of the counter 44, where N is an integer greater than 1 and N is chosen to be equal to 8 in this embodiment. Therefore, the value of the counter 44 becomes one, indicating that the counting signal S0 is at the high level while the counting signal S1 is at the low level. At last, the pulse oscillating signal PL is equal to the oscillating signal F31, the oscillating signal D1 is equal to the oscillating signal F21, and the oscillating signal D2 is equal to the oscillating signal F11. The frequency of the pulse oscillating signal will be modulated to be equal to 0.5° F.

FIG. 5(b) shows that the frequency of the pulse oscillating signal PL is modulated to be 0.5° F. and the period of the oscillating signal PL is modulated to be 2*T. The pulse widths w1 and w2 are kept unchanged. When the duty cycle D is greater than 1−F*w1/2, the control signal CNTUP keeps at the high level and the control signal CLR keeps at the low level. Then if the duty cycle D is greater than 1−F*w1/2 for N consecutive periods of the pulse oscillating signal PL, the counter 43 will generate the rising-edge control signal C1 so as to specify an upcount of the counter 44. The value of the counter 44 becomes two, indicating that the counting signal S0 is at the low level while the counting signal S1 is at the high level. At last, the pulse oscillating signal PL is equal to the oscillating signal F32, the oscillating signal D1 is equal to the oscillating signal F22, and the oscillating signal D2 is equal to the oscillating signal F12. The frequency of the pulse oscillating signal will be further modulated to be equal to 0.25° F.

FIG. 5(c) shows that the frequency of the pulse oscillating signal PL is modulated to be 0.5° F. and the period of the oscillating signal PL is modulated to be 2*T. The pulse widths w1 and w2 are kept unchanged. When the duty cycle D is less than 1−F*w2/2, the control signal CNTUP is changed to be the low level while the control signal CLR keeps at the low level. Then if the duty cycle D is less than 1−F*w2/2 for N consecutive periods of the pulse oscillating signal PL, the counter 43 will generate the rising-edge control signal C1 so as to specify a downcount of the counter 44. The value of the counter 44 becomes zero, indicating that the counting signals S0 and S1 are at the low level. At last, the pulse oscillating signal PL is equal to the oscillating signal OSC, the oscillating signal D1 is equal to the oscillating signal F20, and the oscillating signal D2 is equal to the oscillating signal F10. The frequency of the pulse oscillating signal will be modulated to be equal to F.

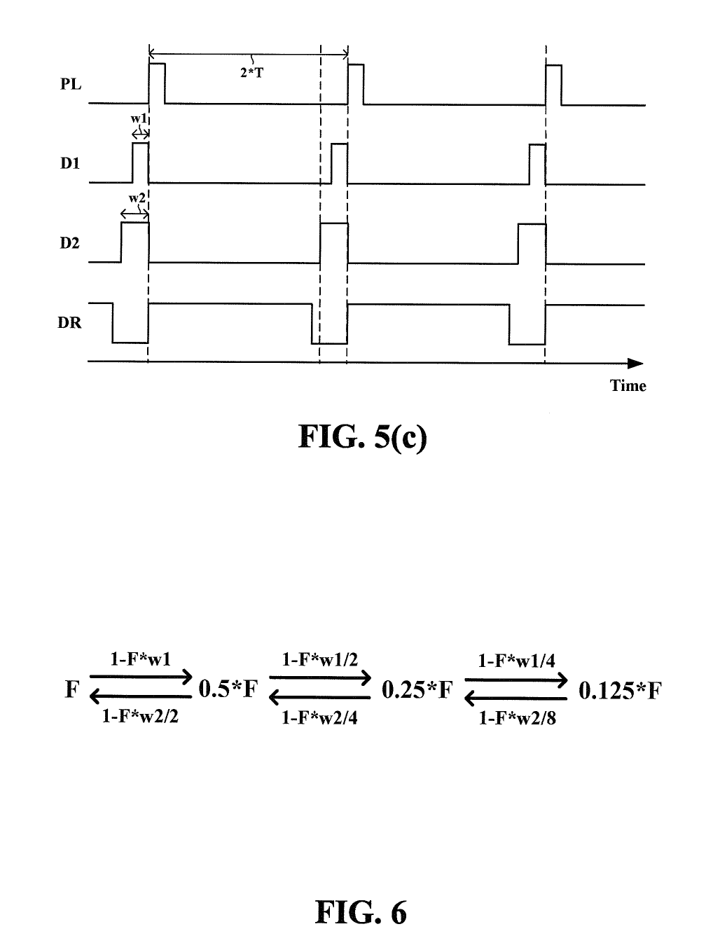

FIG. 6 shows the variation of the frequency of the pulse oscillating signal PL based on the duty cycle D. For example, when the frequency of the pulse oscillating signal PL is 0.25° F., if the duty cycle D is greater than 1−F*w1/4, the frequency of the pulse oscillating signal PL will be modulated to be 0.125° F. If the duty cycle D is less than 1−F*w2/4, the frequency of the pulse oscillating signal PL will be modulated to be 0.5° F. If the duty cycle D is less than 1−F*w1/4 but greater than 1−F*w2/4, the frequency of the pulse oscillating signal PL will be kept to be 0.25° F. Therefore, the ripple of the output voltage Vₒ can be reduced by adaptively modulating the frequency of the pulse oscillating signal PL. Furthermore, the method used in the invention can be applied to a step-up DC to DC power converter as well.

While the invention has been described by way of examples and in terms of the preferred embodiments, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A power converter for converting an input voltage into an output voltage, comprising:
a first switch;
a second switch;
an inductor, wherein the first switch, the second switch, and the inductor are coupled together to a switch node, such that when the first switch is turned on and the second switch is turned off, an inductor current flowing through the inductor increases, but when the first switch is turned off and the second switch is turned on, the inductor current decreases;
a driving circuit for controlling the first switch and the second switch based on a driving signal, wherein the driving signal has a duty cycle; and
an oscillating circuit comprising a first oscillating signal with a first pulse width w1 and a second oscillating signal with a second pulse width w2, wherein:
the oscillating circuit is used to generate a pulse oscillating signal, the pulse oscillating signal has a frequency and the initial value of the frequency is F, and the frequency is modulated based on the duty cycle, the pulse width w1, and the pulse width w2.

2. The power converter according to claim 1, wherein when the frequency is F and the duty cycle is greater than 1−F*w1, the frequency will be modulated to be 0.5° F.

3. The power converter according to claim 2, wherein when the frequency is 0.5° F. and the duty cycle is greater than 1−F*w1/2, the frequency will be modulated to be 0.25° F.

4. The power converter according to claim 3, wherein when the frequency is 0.5° F. and the duty cycle is less than 1−F*w2/2, the frequency will be modulated to be F.

5. The power converter according to claim 4, wherein when the frequency is 0.25° F. and the duty cycle is greater than 1−F*w1/4, the frequency will be modulated to be 0.125° F.

6. The power converter according to claim 5, wherein when the frequency is 0.25° F. and the duty cycle is less than 1−F*w2/4, the frequency will be modulated to be 0.5° F.

7. The power converter according to claim 6, wherein when the frequency is 0.125° F. and the duty cycle is less than 1−F*w2/8, the frequency will be modulated to be 0.25° F.

8. The power converter according to claim 1, wherein the oscillating circuit further comprising:
a counter for generating a first counting signal and a second counting signal;
a control circuit for controlling the counter based on the driving signal, the first oscillating signal, and the second oscillating signal; and
a ramp oscillating circuit for generating a ramp oscillating signal based on the pulse oscillating signal.

9. The power converter according to claim 8, wherein the oscillating circuit further comprising:
a first frequency divider for generating a fourth oscillating signal, a fifth oscillating signal, and a sixth oscillating signal based on a third oscillating signal; and
a first multiplexer for choosing one of the third oscillating signal, the fourth oscillating signal, the fifth oscillating signal, and the sixth oscillating signal to generate the pulse oscillating signal based on the first counting signal and the second counting signal.

10. The power converter according to claim 9, wherein the oscillating circuit further comprising:
a second frequency divider for generating a eighth oscillating signal, a ninth oscillating signal, and a tenth oscillating signal based on a seventh oscillating signal; and
a second multiplexer for choosing one of the seventh oscillating signal, the eighth oscillating signal, the ninth oscillating signal, and the tenth oscillating signal to generate the first oscillating signal based on the first counting signal and the second counting signal.

11. The power converter according to claim 10, wherein the oscillating circuit further comprising:
a third frequency divider for generating a twelfth oscillating signal, a thirteenth oscillating signal, and a fourteenth oscillating signal based on a eleventh oscillating signal; and
a third multiplexer for choosing one of the eleventh oscillating signal, the twelfth oscillating signal, the thirteenth oscillating signal, and the fourteenth oscillating signal to generate the second oscillating signal based on the first counting signal and the second counting signal.

12. The power converter according to claim 11, wherein the oscillating circuit further comprises a one shot, a first comparator, and a first reference voltage source so as to generate the third oscillating signal.

13. The power converter according to claim 12, wherein the oscillating circuit further comprises a second comparator and a second reference voltage source so as to generate the seventh oscillating signal.

14. The power converter according to claim 13, wherein the oscillating circuit further comprises a third comparator and a third reference voltage source so as to generate the eleventh oscillating signal.

15. The power converter according to claim 14, wherein the power converter further comprises a latch, and the latch is used to generate the driving signal based on the pulse oscillating signal.

16. The power converter according to claim 1, wherein w2>2*w1.

17. The power converter according to claim 7, wherein when the frequency is 0.5° F. and the duty cycle is between 1−F*w2/2 and 1−F*w1/2, the frequency will be kept to be 0.5° F.

18. The power converter according to claim 17, wherein when the frequency is 0.25° F. and the duty cycle is between 1−F*w2/4 and 1−F*w1/4, the frequency will be kept to be 0.25° F.

19. The power converter according to claim 16, wherein F is equal to 1 MHz.

20. The power converter according to claim 19, wherein w1 is equal to 100 ns and w2 is equal to 250 ns.
